(19) United States
(12) Patent Application Publication
(10) Pub. No.: US 2025/0263807 A1
(43) Pub. Date: Aug. 21, 2025

(54) METHOD AND AN ARRANGEMENT FOR A CONTINUOUS PRODUCTION OF SPONGE IRON FROM IRON ORE

(71) Applicant: HYBRIT Development AB, Stockholm (SE)

(72) Inventor: Jörgen Östling, Töre (SE)

(21) Appl. No.: 18/867,364

(22) PCT Filed: May 24, 2023
(86) PCT No.: PCT/SE2023/050509

§ 371 Date: Nov. 19, 2024

(30) Foreign Application Priority Data
May 25, 2022 (SE) 2250625-7

(51) Int. Cl. C21B 13/00; C21B 13/02

(52) U.S. Cl. CPC C21B 13/004; C21B 13/0073; C21B 13/02; C21B 2100/64

(57) ABSTRACT

An arrangement for a continuous production of sponge iron from iron ore, including a direct reduction shaft and an arrangement for introducing a pressurized, heated hydrogen-rich reduction gas into the direct reduction shaft to reduce the iron ore and produce sponge iron, and a charge vessel for charging iron ore into the direct reduction shaft, with an inert gas inlet. A control unit is configured to control an inert gas inlet valve based on input from a reduction shaft pressure sensor and a charge vessel pressure sensor to provide pressurized inert gas inside the charge vessel before discharge of iron ore from the charge vessel into the direct reduction shaft, such that the pressure of the inert gas in the charge vessel is lower than or equal to the pressure in the direct reduction shaft, and to close the gas inlet valve during discharge of iron ore from the charge vessel to the direct reduction shaft.

### TECHNICAL FIELD

The present invention relates to a method for a continuous production of sponge iron from iron ore, comprising the steps of: charging iron ore into a direct reduction shaft via a charge vessel, introducing a heated hydrogen-rich reduction gas into the direct reduction shaft in order to reduce the iron ore and produce sponge iron, wherein a process pressure which is above atmospheric pressure is generated in the direct reduction shaft, and extracting the produced sponge iron from the direct reduction shaft via a discharge vessel.

The present invention also relates to an arrangement for a continuous production of sponge iron from iron ore, comprising: a direct reduction shaft an arrangement for introducing a pressurized, heated hydrogen-rich reduction gas into the direct reduction shaft in order to reduce the iron ore and produce sponge iron, a charge vessel for charging iron ore into the direct reduction shaft, and a discharge vessel for discharging sponge iron from the direct reduction shaft.

### BACKGROUND

Arrangements for direct reduction (DR) of iron ore to sponge iron may use a charging vessel and a discharging vessel for the charging of iron ore into the reduction shaft and for the discharge of sponge iron out of the same shaft. Iron ore is charged to the charging vessel, which is first flushed with an inert seal gas to remove air from the vessel. The inert gas is pressurized to a pressure somewhat greater than the operating pressure of the DR shaft using the seal gas. Once pressurized, the valve separating the charging vessel and the DR shaft is opened to allow the iron ore to be introduced to the shaft, together with the pressurized seal gas. In order to prevent permeation of reducing gas into the charging vessel, the vessel is constantly flushed with a flow of seal gas during the charging operation. Once the ore has been charged, the valve can be closed and the charging vessel can be opened to receive a further load of ore for charging. A corresponding set of steps are taken in connection the discharge vessel during discharge of sponge iron from the DR shaft.

Due to the overpressure of the seal gas and the continuous flushing during charging, significant amounts of seal gas enter the DR shaft and dilute the reducing gas. Since seal gas is inert and accumulates in the reducing circuit, this results in the need to flare reducing gas, which is costly (particularly when the reducing gas is expensive electrolytic hydrogen).

### THE OBJECT OF THE INVENTION

It is an object of the present invention present a method and an arrangement for direct reduction of iron ore to sponge iron that reduces dilution of the reduction gas with inert seal gas compared to the above-disclosed prior art. The method and arrangement should be designed in such a way that the losses of seal gas and reduction gas are minimized, thereby contributing to an efficient operation of the arrangement.

### SUMMARY

The object of the invention is achieved by means of method for a continuous production of sponge iron from iron ore, comprising the steps of:
charging iron ore into a direct reduction shaft via a charge vessel,
introducing a heated hydrogen-rich reduction gas into the direct reduction shaft in order to reduce the iron ore and produce sponge iron, wherein a process pressure which is above atmospheric pressure is generated in the direct reduction shaft, and
extracting the produced sponge iron from the direct reduction shaft via a discharge vessel, wherein the step of charging comprises the following steps:
closing an iron ore outlet of the charge vessel gas-tightly in relation to the reduction shaft,
charging the iron ore into the charge vessel via an iron ore inlet into the charge vessel,
closing the iron ore inlet of the charge vessel gas-tightly in relation to the atmosphere,
filling the charge vessel with an inert gas via an inert gas inlet into the charge vessel, and
opening the iron ore outlet and discharging iron ore from the charge vessel into the direct reduction shaft, said method being characterized in that the step of filling the charge vessel with inert gas comprises the steps of measuring the process pressure in the direct reduction shaft and filling the charge vessel with the inert gas up to a pressure which is equal to or below the process pressure in the direct reduction shaft, and in that the inert gas inlet is closed during the opening of the iron ore outlet and discharging of iron ore from the charge vessel into the direct reduction shaft.

According to one embodiment, the step of filling the charge vessel with inert gas comprises filling the charge vessel with inert gas up to a pressure which is less than 2 bar lower than the pressure in the direct reduction shaft. In other words, the difference between the pressure of the inert gas inside the charge vessel and the pressure in direct reduction shaft is not more than 2 bar, when discharge of iron ore into the direct reduction shaft is initiated.

According to one embodiment, the step of filling the charge vessel with inert gas comprises filling the charge vessel with inert gas up to a pressure which is less than 1 bar lower than the pressure in the direct reduction shaft. In other words, the difference between the pressure of the inert gas inside the charge vessel and the pressure in direct reduction shaft is not more than 1 bar, when discharge of iron ore into the direct reduction shaft is initiated.

According to one embodiment, after opening of the iron ore outlet and discharge of the iron ore from the charge vessel into the direct reduction shaft, the iron ore outlet is closed, followed by opening a gas outlet in the charge vessel and flushing inert gas through the charge vessel via the inert gas inlet and the gas outlet of the charge vessel.

According to one embodiment, the pressure in the charge vessel is reduced to approximately atmospheric pressure before the charging of the iron ore into the charge vessel via the iron ore inlet.

According to one embodiment, the inert gas mainly comprises nitrogen gas. The invention thereby also prevents or reduces formation of ammonia inside the direct reduction chamber, since nitrogen to a substantial degree is prevented from leaking into the direct reduction chamber.

According to one embodiment, the hydrogen-rich reduction gas introduced into the direct reduction shaft comprises at least 80 vol. %, preferably at least 90 vol. %, hydrogen gas (vol. % determined at normal conditions of 1 atm. and 0° C.).

The object of the invention is also achieved by means of a method for a continuous production of sponge iron from iron ore, comprising the steps of:
charging iron ore into a direct reduction shaft via a charge vessel,
introducing a heated hydrogen-rich reduction gas into the direct reduction shaft in order to reduce the iron ore and produce sponge iron, wherein a process pressure which is above atmospheric pressure is generated in the direct reduction shaft, and
extracting the produced sponge iron from the direct reduction shaft via a discharge vessel, wherein the step of extracting the sponge iron comprises the following steps:
closing a sponge iron outlet of the discharge vessel gas-tightly in relation to the atmosphere,
closing a sponge iron inlet from the direct reduction shaft to the discharge vessel gas-tightly,
filling the discharge vessel with an inert gas via an inert gas inlet into the discharge vessel,
opening the sponge iron inlet and charging the discharge vessel with sponge iron from the direct reduction shaft via the sponge iron inlet,
closing the sponge iron inlet of the discharge vessel gas-tightly in relation to the direct reduction shaft, and
opening the sponge iron outlet and discharging iron from the discharge vessel, said method being characterized in that the step of filling the discharge vessel with inert gas comprises the steps of measuring the process pressure in the direct reduction shaft and filling the discharge vessel with the inert gas up to a pressure which is equal to or below the process pressure in the direct reduction shaft, and in that the inert gas inlet is closed during the opening of the sponge iron inlet and the charging of the discharge vessel with sponge iron from the direct reduction shaft.

According to one embodiment, the step of filling the discharge vessel with inert gas comprises filling the discharge vessel with inert gas up to a pressure which is less than 2 bar lower than the pressure in the direct reduction shaft. In other words, the difference between the pressure of the inert gas inside the discharge vessel and the pressure in direct reduction shaft is not more than 2 bar, when discharge of sponge iron from the direct reduction shaft is initiated.

According to one embodiment, the step of filling the discharge vessel with inert gas comprises filling the discharge vessel with inert gas up to a pressure which is less than 1 bar lower than the pressure in the direct reduction shaft. In other words, the difference between the pressure of the inert gas inside the discharge vessel and the pressure in direct reduction shaft is not more than 1 bar, when discharge of sponge iron from the direct reduction shaft is initiated.

According to one embodiment, before the opening of the sponge iron outlet and discharge of the sponge iron from the discharge vessel, inert gas is flushed through the discharge vessel via the inert gas inlet and the gas outlet of the discharge vessel.

According to one embodiment, the pressure in the discharge vessel is reduced to approximately atmospheric pressure before the opening of the sponge iron outlet and discharging iron from the discharge vessel.

According to one embodiment, the inert gas mainly comprises nitrogen gas. The invention thereby also prevents or reduces formation of ammonia inside the direct reduction chamber, since nitrogen to a substantial degree is prevented from leaking into the direct reduction chamber.

The object of the invention is also achieved by means of an arrangement for a continuous production of sponge iron from iron ore, comprising
a direct reduction shaft,
an arrangement for introducing a pressurized, heated hydrogen-rich reduction gas into the direct reduction shaft in order to reduce the iron ore and produce sponge iron,
a charge vessel for charging iron ore into the direct reduction shaft,
a discharge vessel for discharging sponge iron from the direct reduction shaft,
an iron ore inlet for charge of iron ore into the charge vessel,
an inlet valve arranged at the iron ore inlet and configured to close the iron ore inlet gas-tightly,
an iron ore outlet for discharge of iron ore from the charge vessel into the direct reduction shaft,
an outlet valve arranged at the iron ore outlet and configured to close the iron ore outlet gas-tightly,
an inert gas source, configured to provide pressurized inert gas to the charge vessel,
an inert gas inlet for introduction of inert gas into the charge vessel, with a gas inlet valve for controlling the flow of inert gas into the charge vessel, and
a gas outlet for discharge of gas from the charge vessel, with a gas outlet valve device for controlling a flow of gas out of the charge vessel, and
a reduction shaft pressure sensor for measuring the gas pressure inside the direct reduction shaft and
a charge vessel pressure sensor for measuring the inert gas pressure in the charge vessel, said arrangement being characterized in that it comprises a control unit configured to control the gas inlet valve on basis of input from the reduction shaft pressure sensor and the charge vessel pressure sensor to provide pressurized inert gas inside the charge vessel before discharge of iron ore from the charge vessel into the direct reduction shaft, such that the pressure of the inert gas in the charge vessel is lower than or equal to the pressure in the direct reduction shaft and to close the gas inlet valve during discharge of iron ore from the charge vessel to the direct reduction shaft.

According to one embodiment, the control unit is configured to control the gas inlet valve on basis of input from the reduction shaft pressure sensor and the charge vessel pressure sensor to provide pressurized inert gas inside the charge vessel before discharge of iron ore from the charge vessel into the direct reduction shaft and such that the pressure of the inert gas in the charge vessel is less than 2 bar lower than the pressure in the direct reduction shaft.

According to one embodiment, the control unit is configured to control the gas inlet valve on basis of input from the reduction shaft pressure sensor and the charge vessel pressure sensor to provide pressurized inert gas inside the charge vessel before discharge of iron ore from the charge vessel into the direct reduction shaft and such that the pressure of the inert gas in the charge vessel is less than 1 bar lower than the pressure in the direct reduction shaft.

The object of the invention is also achieved by means of an arrangement for a continuous production of sponge iron from iron ore, comprising
a direct reduction shaft,
an arrangement for introducing a pressurized, heated hydrogen-rich reduction gas into the direct reduction shaft in order to reduce the iron ore and produce sponge iron,
a charge vessel for charging iron ore into the direct reduction shaft,
a discharge vessel for discharging sponge iron from the direct reduction shaft,
a sponge iron inlet for charge of sponge iron into the discharge vessel,
an inlet valve arranged at the sponge iron inlet and configured to close the sponge iron inlet gas-tightly,
a sponge iron outlet for discharge of sponge iron from the discharge vessel,
an outlet valve arranged at the sponge iron outlet and configured to close the sponge iron outlet gas-tightly,
an inert gas source, configured to provide pressurized inert gas to the discharge vessel,
an inert gas inlet for introduction of inert gas into the discharge vessel, with a gas inlet valve for controlling the flow of inert gas into the discharge vessel, and
a gas outlet for discharge of gas from the discharge vessel, with a gas outlet valve for controlling a flow of gas out of the discharge vessel, and
a reduction shaft pressure sensor for measuring the gas pressure inside the direct reduction shaft and
a discharge vessel pressure sensor for measuring the inert gas pressure in the discharge vessel, said arrangement being characterized in that it comprises a control unit configured to control the gas inlet valve of the discharge vessel on basis of input from the reduction shaft pressure sensor and the discharge vessel pressure sensor to provide pressurized inert gas inside the discharge vessel before charge of sponge iron into the discharge vessel, such that the pressure of the inert gas in the discharge vessel is lower than or equal to the pressure in the direct reduction shaft, and to close the gas inlet valve during charge of sponge iron from direct reduction shaft into the discharge vessel.

According to one embodiment, the control unit is configured to control the gas inlet valve on basis of input from the reduction shaft pressure sensor and the discharge vessel pressure sensor to provide pressurized inert gas inside the discharge vessel before charge of sponge iron from the direct reduction shaft into the discharge vessel, such that the pressure of the inert gas in the discharge vessel is less than 2 bar lower than the pressure in the direct reduction shaft.

According to one embodiment, the control unit is configured to control the gas inlet valve on basis of input from the reduction shaft pressure sensor and the discharge vessel pressure sensor to provide pressurized inert gas inside the discharge vessel before charge of sponge iron from the direct reduction shaft into the discharge vessel and such that the pressure of the inert gas in the discharge vessel is less than 1 bar lower than the pressure in the direct reduction shaft.

### BRIEF DESCRIPTION OF THE DRAWING

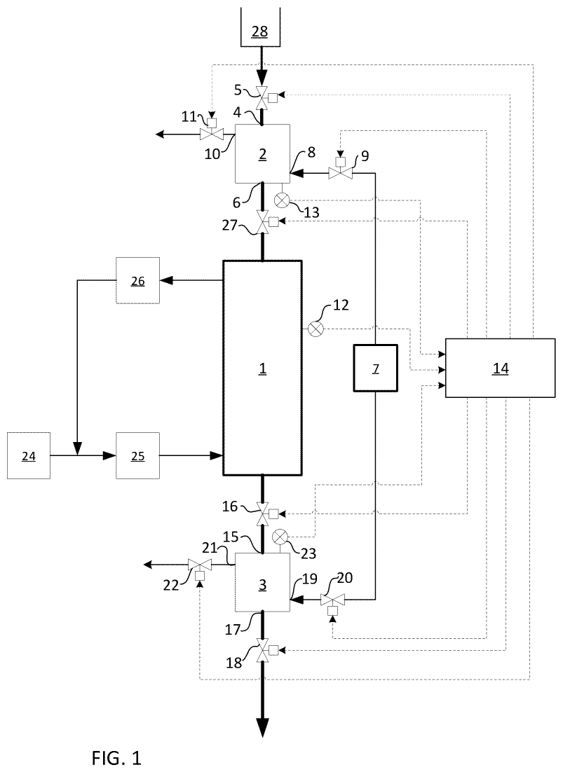

Embodiments of the invention will be disclosed with reference to FIG. 1, which shows a schematic representation of an arrangement according to the present invention.

### DETAILED DESCRIPTION

FIG. 1 shows an embodiment of an arrangement for a continuous production of sponge iron from iron ore. The arrangement comprises a direct reduction shaft 1 and an arrangement 24, 25, 26 for introducing a pressurized, heated hydrogen-rich reduction gas into the direct reduction shaft 1 in order to reduce the iron ore and produce sponge iron, a charge vessel 2 for charging iron ore into the direct reduction shaft 1, a feeding device 28 for feeding of iron ore into the charge vessel 2, and a discharge vessel 3 for discharging sponge iron from the direct reduction shaft 1. Furthermore there is provided an iron ore inlet 4 for charge of iron ore into the charge vessel 2, an inlet valve 5 arranged at the iron ore inlet 4 and configured to close the iron ore inlet 4 gas-tightly, an iron ore outlet 6 for discharge of iron ore from the charge vessel 2 into the direct reduction shaft 1, an outlet valve 27 arranged at the iron ore outlet 6 and configured to close the iron ore outlet 6 gas-tightly, an inert gas source 7, configured to provide pressurized inert gas to the charge vessel 2, an inert gas inlet 8 for introduction of inert gas into the charge vessel 2, with a gas inlet valve 9 for controlling the flow of inert gas into the charge vessel 2, and a gas outlet 10 for discharge of gas from the charge vessel 2, with a gas outlet valve 11 device for controlling a flow of gas out of the charge vessel 2, and a reduction shaft pressure sensor 12 for measuring the gas pressure inside the direct reduction shaft 1 and a charge vessel 2 pressure sensor 13 for measuring the inert gas pressure in the charge vessel 2.

The 24, 25, 26 for introducing a pressurized, heated hydrogen-rich reduction gas into the direct reduction shaft 1 comprises a hydrolyser 24 for the production of hydrogen gas, a heater 25 for heating the hydrogen gas before its entrance into the direct reduction shaft 1, and a process gas recycling circuit with a treatment device for cleaning etc. of off gas from the direction reduction shaft 1 that is mixed with the hydrogen from the hydrolyser 24 to form the hydrogen-rich reduction gas that is used for the direct reduction of the iron ore to sponge iron. The hydrogen-rich reduction gas comprises at least 90 vol. % hydrogen gas (vol. % determined at normal conditions of 1 atm. and 0° C.).

The arrangement for a continuous production of sponge iron from iron ore further comprises a control unit 14 configured to control the gas inlet valve 9 on basis of input from the reduction shaft 1 pressure sensor 12 and the charge vessel pressure sensor 13 to provide pressurized inert gas inside the charge vessel 2 before discharge of iron ore from the charge vessel 2 into the direct reduction shaft 1, such that the pressure of the inert gas in the charge vessel 2 is generally equal to the pressure in the direct reduction shaft 1, and to close the gas inlet valve during 9 discharge of iron ore from the charge vessel 2 to the direct reduction shaft 1.

The arrangement for a continuous production of sponge iron from iron ore further comprises a sponge iron inlet 15 for charge of sponge iron into the discharge vessel 3, an inlet valve 16 arranged at the sponge iron inlet 15 and configured to close the sponge iron inlet 15 gas-tightly, a sponge iron outlet 17 for discharge of sponge iron from the discharge vessel 3, an outlet valve 18 arranged at the sponge iron outlet 17 and configured to close the sponge iron outlet 17 gas-tightly. The inert gas source 7 is configured to provide pressurized inert gas to the discharge vessel 3. Further, there is provided an inert gas inlet 19 for introduction of inert gas into the discharge vessel 3, with a gas inlet valve 20 for controlling the flow of inert gas into the discharge vessel 3, and a gas outlet 21 for discharge of gas from the discharge vessel 3, with a gas outlet valve 22 for controlling a flow of gas out of the discharge vessel 3. There is also provided a discharge vessel pressure sensor 23 for measuring the inert gas pressure in the discharge vessel 3.

The control unit 14 is configured to control the gas inlet valve 20 of the discharge vessel 3 on basis of input from the reduction shaft pressure sensor 23 and the discharge vessel pressure sensor 23 to provide pressurized inert gas inside the discharge vessel 3 before charge of sponge iron into the discharge vessel 3, such that the pressure of the inert gas in the discharge vessel 3 is generally equal to the pressure in the direct reduction shaft 1, and to close the gas inlet valve 20 during charge of sponge iron from direct reduction shaft 1 into the discharge vessel 3.

The iron ore inlet valve 5, the iron ore outlet valve 27, the sponge iron inlet valve 16 and the sponge iron outlet valve 18 are control valves configured to be controlled by means of the control unit 14.

The gas inlet valves 9 and 20, and the gas outlet valves 11 and 22 are control valves configured to be controlled by means of the control unit 14. The inert gas source 7 is configured to deliver inert gas having an elevated pressure. Preferably the inert gas mainly comprises nitrogen gas.

The arrangement for a continuous production of sponge iron from iron ore is configured to perform a method according to the present invention, which method comprises the sequential steps of:
charging iron ore into the direct reduction shaft 1 via the charge vessel 2,
introducing a heated hydrogen-rich reduction gas into the direct reduction shaft 1 in order to reduce the iron ore and produce sponge iron, wherein a process pressure which is above atmospheric pressure is generated in the direct reduction shaft 1, and
extracting the produced sponge iron from the direct reduction shaft 1 via a discharge vessel 3,
wherein the step of charging comprises the following steps:
closing the iron ore outlet 6 of the charge vessel 2 gas-tightly in relation to the reduction shaft 1,
charging the iron ore into the charge vessel 2 via the iron ore inlet 4 into the charge vessel 2,
closing the iron ore inlet 4 of the charge vessel 2 gas-tightly in relation to the atmosphere,
filling the charge vessel 2 with an inert gas via the inert gas inlet 8 into the charge vessel 2, and
opening the iron ore outlet 6 and discharging iron ore from the charge vessel 2 into the direct reduction shaft 1.

The step of filling the charge vessel 2 with inert gas comprises the steps of measuring the process pressure in the direct reduction shaft 1 and filling the charge vessel 2 with the inert gas up to a pressure which is generally equal to the process pressure in the direct reduction shaft 1, wherein the inert gas inlet 8 is closed during the opening of the iron ore outlet 6 and discharging of iron ore from the charge vessel 2 into the direct reduction shaft 1.

After opening of the iron ore outlet 6 and discharge of the iron ore from the charge vessel 2 into the direct reduction shaft 1, the iron ore outlet 6 is closed, followed by opening of the gas outlet 10 in the charge vessel 2 and flushing inert gas through the charge vessel 2 via the inert gas inlet 8 and the gas outlet 10 of the charge vessel. Thereby, the pressure in the charge vessel 2 is reduced to approximately atmospheric pressure before a following next charging of iron ore into the charge vessel 2 via the iron ore inlet 4.

The arrangement for a continuous production of sponge iron from iron ore is also configured to perform a method according to the present invention, which method comprises the sequential steps of:
charging iron ore into the direct reduction shaft 1 via a charge vessel 2,
introducing a heated hydrogen-rich reduction gas into the direct reduction shaft 1 in order to reduce the iron ore and produce sponge iron, wherein a process pressure which is above atmospheric pressure is generated in the direct reduction shaft 1, and
extracting the produced sponge iron from the direct reduction shaft 1 via the discharge vessel 3, wherein the step of extracting the sponge iron comprises the following steps:
closing the sponge iron outlet 17 of the discharge vessel 3 gas-tightly in relation to the atmosphere,
closing the sponge iron inlet 15 from the direct reduction shaft 1 to the discharge vessel 3 gas-tightly,
filling the discharge vessel 3 with an inert gas via the inert gas inlet 19 into the discharge vessel 3,
opening the sponge iron inlet 15 and charging the discharge vessel 3 with sponge iron from the direct reduction shaft 1 via the sponge iron inlet 15,
closing the sponge iron inlet 15 of the discharge vessel 3 gas-tightly in relation to the direct reduction shaft 1, and
opening the sponge iron outlet 17 and discharging sponge iron from the discharge vessel 3.

The step of filling the discharge vessel 3 with inert gas comprises the steps of measuring the process pressure in the direct reduction shaft 1 and filling the discharge vessel 3 with the inert gas up to a pressure which is generally equal to the process pressure in the direct reduction shaft 1, wherein the inert gas inlet 19 is closed during the opening of the sponge iron inlet 15 and the charging of the discharge vessel 3 with sponge iron from the direct reduction shaft 1.

Before the opening of the sponge iron outlet 17 and discharge of the sponge iron from the discharge vessel 3, inert gas is flushed through the discharge vessel 3 via the inert gas inlet 1 and the gas outlet 21 of the discharge vessel 3. Thereby, the pressure in the discharge vessel 3 is reduced to approximately atmospheric pressure before the opening of the sponge iron outlet 17 and discharging iron from the discharge vessel 3.

1. A method for a continuous production of sponge iron from iron ore, the method comprising the steps of:
charging iron ore into a direct reduction shaft via a charge vessel,
introducing a heated hydrogen-rich reduction gas into the direct reduction shaft in order to reduce the iron ore and produce sponge iron, wherein a process pressure which is above atmospheric pressure is generated in the direct reduction shaft, and
extracting the produced sponge iron from the direct reduction shaft via a discharge vessel,
wherein the step of charging comprises the following steps:
closing an iron ore outlet of the charge vessel gas-tightly in relation to the reduction shaft,
charging the iron ore into the charge vessel via an iron ore inlet into the charge vessel,
closing the iron ore inlet of the charge vessel gas-tightly in relation to the atmosphere,
filling the charge vessel with an inert gas via an inert gas inlet into the charge vessel, and
opening the iron ore outlet and discharging iron ore from the charge vessel into the direct reduction shaft, wherein the step of filling the charge vessel with inert gas comprises the steps of measuring the process pressure in the direct reduction shaft and filling the charge vessel with the inert gas up to a pressure which is equal to or below the process pressure in the direct reduction shaft, and wherein the inert gas inlet is closed during the opening of the iron ore outlet and discharging of iron ore from the charge vessel into the direct reduction shaft.

2. The method according to claim 1, wherein the step of filling the charge vessel with inert gas comprises filling the charge vessel with inert gas up to a pressure which is less than 2 bar lower than the than the pressure in the direct reduction shaft.

3. The method according to claim 1, wherein the step of filling the charge vessel with inert gas comprises filling the charge vessel with inert gas up to a pressure which is less than 1 bar lower than the pressure in the direct reduction shaft.

4. The method according to claim 1, wherein, after opening of the iron ore outlet and discharge of the iron ore from the charge vessel into the direct reduction shaft, the iron ore outlet is closed, followed by opening a gas outlet in the charge vessel and flushing inert gas through the charge vessel via the inert gas inlet and the gas outlet of the charge vessel.

5. The method according to claim 1, wherein the pressure in the charge vessel is reduced to approximately atmospheric pressure before the charging of the iron ore into the charge vessel via the iron ore inlet.

6. The method for a continuous production of sponge iron from iron ore, the method comprising the steps of:
charging iron ore into a direct reduction shaft via a charge vessel,
introducing a heated hydrogen-rich reduction gas into the direct reduction shaft
in order to reduce the iron ore and produce sponge iron, wherein a process pressure which is above atmospheric pressure is generated in the direct reduction shaft, and
extracting the produced sponge iron from the direct reduction shaft via a discharge vessel,
wherein the step of extracting the sponge iron comprises the following steps:
closing a sponge iron outlet of the discharge vessel gas-tightly in relation to the atmosphere,
closing a sponge iron inlet from the direct reduction shaft to the discharge vessel gas-tightly,
filling the discharge vessel with an inert gas via an inert gas inlet into the discharge vessel,
opening the sponge iron inlet and charging the discharge vessel with sponge iron from the direct reduction shaft via the sponge iron inlet,
closing the sponge iron inlet of the discharge vessel gas-tightly in relation to the direct reduction shaft, and
opening the sponge iron outlet and discharging iron from the discharge vessel, wherein the step of filling the discharge vessel with inert gas comprises the steps of measuring the process pressure in the direct reduction shaft and filling the discharge vessel with the inert gas up to a pressure which is equal to or below the process pressure in the direct reduction shaft, and wherein the inert gas inlet is closed during the opening of the sponge iron inlet and the charging of the discharge vessel with sponge iron from the direct reduction shaft.

7. The method according to claim 6, wherein the step of filling the discharge vessel with inert gas comprises filling the discharge vessel with inert gas up to a pressure which is less than 2 bar lower than the pressure in the direct reduction shaft.

8. The method according to claim 6, wherein the step of filling the discharge vessel with inert gas comprises filling the discharge vessel with inert gas up to a pressure which is less than 1 bar lower than the pressure in the direct reduction shaft.

9. The method according to claim 6, wherein, before the opening of the sponge iron outlet and discharge of the sponge iron from the discharge vessel, inert gas is flushed through the discharge vessel via the inert gas inlet and the gas outlet of the discharge vessel.

10. The method according to claim 6, wherein the pressure in the discharge vessel is reduced to approximately atmospheric pressure before the opening of the sponge iron outlet and discharging iron from the discharge vessel.

11. An arrangement for a continuous production of sponge iron from iron ore, the arrangement comprising:
a direct reduction shaft,
an arrangement for introducing a pressurized, heated hydrogen-rich reduction gas into the direct reduction shaft in order to reduce the iron ore and produce sponge iron,
a charge vessel for charging iron ore into the direct reduction shaft,
a discharge vessel for discharging sponge iron from the direct reduction shaft,
an iron ore inlet for charge of iron ore into the charge vessel,
an inlet valve arranged at the iron ore inlet and configured to close the iron ore inlet gas-tightly,
an iron ore outlet for discharge of iron ore from the charge vessel into the direct reduction shaft,
an outlet valve arranged at the iron ore outlet and configured to close the iron ore outlet gas-tightly,
an inert gas source configured to provide pressurized inert gas to the charge vessel,
an inert gas inlet for introduction of inert gas into the charge vessel, with a gas inlet valve for controlling the flow of inert gas into the charge vessel, and
a gas outlet for discharge of gas from the charge vessel, with a gas outlet valve device for controlling a flow of gas out of the charge vessel,
a reduction shaft pressure sensor for measuring the gas pressure inside the direct reduction shaft, and
a charge vessel pressure sensor for measuring the inert gas pressure in the charge vessel, wherein the arrangement comprises a control unit configured to control the gas inlet valve based on input from the reduction shaft pressure sensor and the charge vessel pressure sensor to provide pressurized inert gas inside the charge vessel before discharge of iron ore from the charge vessel into the direct reduction shaft, such that the pressure of the inert gas in the charge vessel is lower than or equal to the pressure in the direct reduction shaft, and to close the gas inlet valve during discharge of iron ore from the charge vessel to the direct reduction shaft.

12. The arrangement according to claim 11, wherein the control unit is configured to control the gas inlet valve based on input from the reduction shaft pressure sensor and the charge vessel pressure sensor to provide pressurized inert gas inside the charge vessel before discharge of iron ore from the charge vessel into the direct reduction shaft and such that the pressure of the inert gas in the charge vessel is less than 2 bar lower than the pressure in the direct reduction shaft.

13. The arrangement according to claim 11, wherein the control unit is configured to control the gas inlet valve based on input from the reduction shaft pressure sensor and the charge vessel pressure sensor to provide pressurized inert gas inside the charge vessel before discharge of iron ore from the charge vessel into the direct reduction shaft and such that the pressure of the inert gas in the charge vessel is less than 1 bar lower than the pressure in the direct reduction shaft.

14. An arrangement for a continuous production of sponge iron from iron ore, the arrangement comprising:
a direct reduction shaft,
an arrangement for introducing a pressurized, heated hydrogen-rich reduction gas into the direct reduction shaft in order to reduce the iron ore and produce sponge iron,
a charge vessel for charging iron ore into the direct reduction shaft,
a discharge vessel for discharging sponge iron from the direct reduction shaft,
a sponge iron inlet for charge of sponge iron into the discharge vessel,
an inlet valve arranged at the sponge iron inlet and configured to close the sponge iron inlet gas-tightly,
a sponge iron outlet for discharge of sponge iron from the discharge vessel,
an outlet valve arranged at the sponge iron outlet and configured to close the sponge iron outlet gas-tightly,
an inert gas source, configured to provide pressurized inert gas to the discharge vessel,
an inert gas inlet for introduction of inert gas into the discharge vessel, with a gas inlet valve for controlling the flow of inert gas into the discharge vessel, and
a gas outlet for discharge of gas from the discharge vessel, with a gas outlet valve for controlling a flow of gas out of the discharge vessel,
a reduction shaft pressure sensor for measuring the gas pressure inside the direct reduction shaft, and
a discharge vessel pressure sensor for measuring the inert gas pressure in the discharge vessel, wherein the arrangement comprises a control unit configured to control the gas inlet valve of the discharge vessel based on input from the reduction shaft pressure sensor and the discharge vessel pressure sensor to provide pressurized inert gas inside the discharge vessel before charge of sponge iron into the discharge vessel, such that the pressure of the inert gas in the discharge vessel is lower than or equal to the pressure in the direct reduction shaft, and to close the gas inlet valve during charge of sponge iron from direct reduction shaft into the discharge vessel.

15. An arrangement according to claim 14, wherein the control unit is configured to control the gas inlet valve on basis of input from the reduction shaft pressure sensor and the discharge vessel pressure sensor to provide pressurized inert gas inside the discharge vessel before charge of sponge iron from the direct reduction shaft into the discharge vessel, such that the pressure of the inert gas in the discharge vessel is less than 2 bar lower than the pressure in the direct reduction shaft.

16. An arrangement according to claim 14, wherein the control unit is configured to control the gas inlet valve on basis of input from the reduction shaft pressure sensor and the discharge vessel pressure sensor to provide pressurized inert gas inside the discharge vessel before charge of sponge iron from the direct reduction shaft into the discharge vessel and such that the pressure of the inert gas in the discharge vessel is less than 1 bar lower than the pressure in the direct reduction shaft.
